(19) United States
(12) Patent Application Publication
(10) Pub. No.: US 2017/0249645 A1
(43) Pub. Date: Aug. 31, 2017

(54) MOBILE DEVICE

(71) Applicant: SICPA HOLDING SA, Prilly (CH)

(72) Inventor: Sandro SAITTA, Epalinges (CH)

(73) Assignee: SICPA HOLDING SA, Prilly (CH)

(21) Appl. No.: 15/500,068

(22) PCT Filed: Jun. 10, 2015
(86) PCT No.: PCT/EP2015/062918

§ 371 Date: Jan. 29, 2017

(30) Foreign Application Priority Data
Jul. 29, 2014 (EP) 14178893.5

(51) Int. Cl. G06Q 30/00; G06K 7/14; G06Q 10/04

(52) U.S. Cl. CPC G06Q 30/0185; G06Q 10/04; G06K 7/1413; G06K 2007/10524

(57) ABSTRACT

A mobile device includes a code capturing entity adapted to capture a data code associated with an item, an entity adapted to determine whether a captured data code is authentic and to generate authentication information as a result, and to decode the captured data code to obtain decoded information, and an output entity. The mobile device is adapted such that the authentication information and the decoded information are sent to a processing entity which receives the authentication information and the decoded information and generates, based on the authentication information and the decoded information by using a stored prediction model, an indication for a next code to be captured; and the output entity is arranged to output information relating to an item and location associated with said next code to be captured based on said indication.

### FIELD OF THE INVENTION

The invention relates to a mobile device, a network component, a method for operating a mobile device, and a method for operating a network entity.

### BACKGROUND OF THE INVENTION

The present invention is in the general field of code capturing and evaluation. An example of this is the machine supported inspection of codes applied to products and items, such as production codes that are evaluated for logistical purposes and/or for the purpose of checking compliance with tax or customs regulations. This process is sometimes also referred to as auditing.

Code inspection devices are known, for example hand-held scanners that read one or two dimensional barcodes on products and output an inspection result on a screen to the user of the scanner. The inspection result typically indicates whether or not the code is authentic, which means that it fulfills one or more predetermined authenticity criteria, and if the code is authentic, the encoded information is also displayed, for example information such as production date, a product identifier, etc. The user can then take desired or prescribed action in response to the received authentication information and decoded information.

In the field of code inspection and auditing, it has been proposed to use web-based systems for collecting and evaluating data. US 2009/0089125 A1 e.g. describes a web-based system providing risk analysis for customs inspection. Using a web interface, customs inspection details are provided to a central server. Once the custom declaration is received, the server performs risk analysis and determines whether or not to initiate an inspection process.

Yaqin et al, Classification Model Based on Association Rules in Customs Risk Management Application, International Conference on Intelligent System Design and Engineering Application, vol. 1, pp. 436-439, 2010 proposes using association rules in customs inspections.

Laporte, Risk Management Systems: Using Data Mining in Developing Countries' Customs Administrations. World Customs Journal, 5(1): pp 17-27 (2011) and Geourjon et al, Inspecting Less to Inspect Better. In: T. Cantens, R. Ireland, and G. Raballand (eds.) Reform by Numbers: Measurement Applied to Customs and Tax Administrations in Developing Countries. pp. 83-101 Washington D.C., The World Bank (2013) proposes to use data mining for risk-management in customs inspections to improve efficiency. These articles suggest using past tax declaration data to calculate a risk measure for a given declaration, and then decide on the intrusiveness of examination in the case depending on the calculated risk.

Han et al, What Happened to the Selected? Performance Measurement of the Korea Customs Service Selectivity System, Research paper 27, World Customs Organization (2013) analyses in the context of risk management three different selection techniques applicable during customs inspections: manual selection, rule-based selection, and random selection.

### SUMMARY OF THE INVENTION

The present invention relates to an improved technology for conducting code inspection.

According to one embodiment, a mobile device is provided, comprising:

a code capturing entity adapted to capture a data code associated with an item;

an entity adapted to determine whether a captured data code is authentic and to generate authentication information as a result, and to decode the captured data code to obtain decoded information;

an output entity; and

wherein the mobile device is adapted such that the authentication information and the decoded information are sent to a processing entity which receives the authentication information and the decoded information and generates, based on the authentication information and the decoded information by using a stored prediction model, an indication for a next code to be captured; and the output entity is arranged to output information relating to an item and location associated with said next code to be captured based on said indication.

Using the mobile device of the described kind, a user thus not only obtains information on the result of the code evaluation, but additionally is provided with information on a future inspection target in terms of item and location, which significantly enhances the utility of the mobile device as an inspection tool.

According to another embodiment, a network component is provided, comprising:

an information database comprising decoded information obtained from decoded data codes and authentication information obtained from an authentication operation performed on data codes;

a training entity adapted to generate a prediction model based on the decoded information and the authentication information; and

a communication entity adapted to send the prediction model to a mobile device to update a processing module in said mobile device.

The network component of the described kind provides the effect that the mobile device is equipped with a processing module that can on its own generate an indication for a next code to be captured, i.e. locally and without connection to an appropriate server in a remote network, because it stores the prediction model in its own memory. The prediction model is dynamically updated when a connection to the network component is available. This has several advantages. The mobile device itself is highly effective, as it can operate without a network connection for outputting information relating to an item and location associated with a next code to be captured. At the same time the prediction model involved is nonetheless not static. This affords the advantage that the mobile device is highly useful because it can provide its basic functionality without an outside connection, but at the same time it can be kept simple in construction despite its capacity for dynamic update of the stored prediction model, as the infrastructure (both in terms of processing capability and memory) for updating the prediction model is provided in the network component instead of in the mobile device.

### BRIEF DESCRIPTION OF FIGURES

The present invention will now be described with reference to specific embodiments that are illustrative but not intended to be limiting.

FIG. 1 shows a schematic representation of a mobile device according to an embodiment of the invention;

FIG. 2 shows a schematic representation of a mobile device according to another embodiment of the invention;

FIG. 3 shows a schematic representation of a network component according to an embodiment of the present invention;

FIG. 4 shows a flowchart of a method according to an embodiment of the present invention;

FIG. 5 shows a flowchart of a method according to another embodiment of the present invention;

FIG. 6 a flowchart of a method according to a further embodiment of the present invention;

FIG. 7 shows a further embodiment of the invention; and

FIG. 8 shows a schematic representation of a decision tree for explaining an embodiment of model construction.

### DETAILED DESCRIPTION

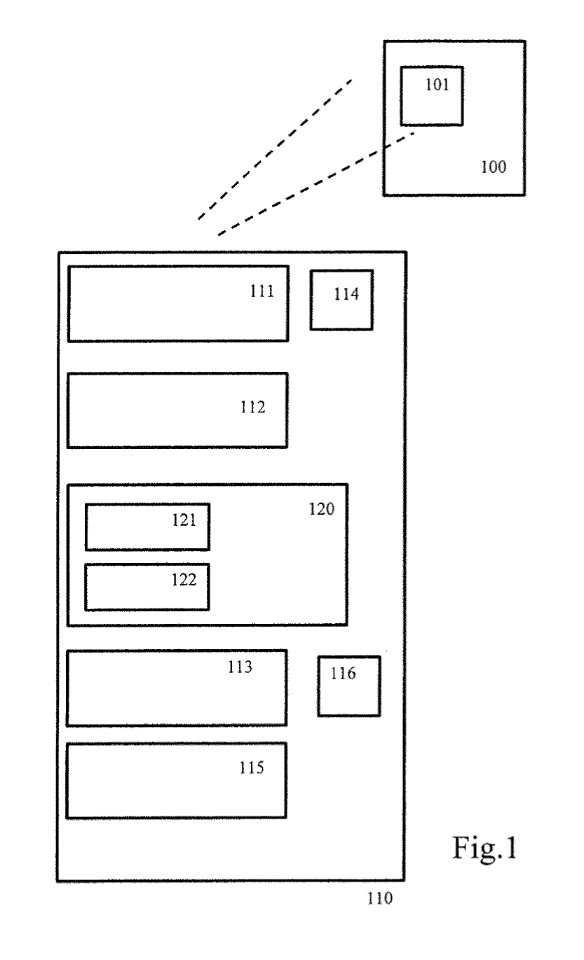

FIG. 1 schematically shows a first example of the present invention. Reference numeral 110 relates to a mobile device. A mobile device is any apparatus that a user is capable of moving from one location to another. For example, the mobile device 110 can be a device dedicated to the task of code capturing and processing, such as a handheld scanner. However, the mobile device can also be a general-purpose apparatus comprising programming for the code capturing and processing task, such as a programmable portable computer, a programmable telephone like e.g. a smart phone, a tablet computer, etc.

Reference number 111 relates to a code capturing entity that is adapted to capture a data code 101 associated with an item 100. The item 100 can be of any suitable type and is preferably a product output by a production facility, such as a package of goods or an individual item destined for sale, such as a pack of cigarettes or a bottle containing a beverage. The data code 101, which comprises a series of data symbols represented in a predetermined format and encoding information according to a predetermined code scheme, can be provided in any suitable way for code capturing, for example can be printed on the item 100 itself, or on a label attached to the item 100. Such a printed code may be visible to the human eye, but can equally also be provided in invisible fashion, so that it can only be recognized with a detector adjusted to the specific optical characteristics of the printed code. If the code is designed to be optically detected, then code capturing entity 111 will be adapted for optical recognition, for example by having a camera sensitive in the optical range in which the code reflects radiation. The code capturing entity 111 can then furthermore comprise a known suitable image processing system that can identify and isolate the data code 101 in captured image information.

It is noted that for the purpose of the present description, the term ‘entity’ refers to hardware, software or any suitable combination of hardware and software designed to provide an indicated functionality.

The presentation of the code can be in any suitable or desirable way, for example it can be a one or two dimensional barcode or some other form of data matrix.

The code can also be provided in other ways, for example could be carried in an RFID tag, in which case the code capturing entity 111 comprises a suitable radiofrequency detector and a system for identifying and processing information contained in radiofrequency signals.

The mobile device 110 furthermore comprises an entity 112 that is adapted to determine whether a captured data code is authentic and to generate authentication information as a result. Such a determination can be done in any suitable fashion, for example by applying one or more predetermined authenticity criteria to the captured data code. Examples of such authenticity criteria are the format of the code, the uniqueness of the code etc. The authentication information indicates the result of the determination, and can for example express “authentic”, “not authentic” or “no decision possible”, but can also comprise further categories that express different degrees of probability regarding the authenticity. Procedures for code authentication are well known in the art and do not need to be described in further detail here.

Entity 112 is furthermore adapted to decode the captured data code, in order to obtain decoded information. In other words, entity 112 has processing capabilities that are adapted to the format and encoding scheme used to produce the data code 101, in order to derive the information contained in the data code 101.

In the example of FIG. 1 a processing entity 120 is provided as a part of the mobile device 110. The mobile device 110 is arranged such that entity 112 sends the authentication information and the decoded information to the 120, which in turn receives the authentication information and the decoded information, in order to generate an indication for a next code to be captured. This process uses a stored prediction model and is based on the authentication information and the decoded information. For this purpose the processing entity 120 comprises a memory part 121 and a processing part 122. The memory part 121 stores the prediction model and the processing part 122 executes the processing that applies the received authentication information and decoded information to the stored model, in order to make a prediction of a next suitable target for code capturing and code examination.

The prediction model can be provided in any suitable fashion. For example, it can be rule-based. This can e.g. be in the form of a set of rules that express if-then-conditions, i.e. comprises a number of rules that connect specific input conditions with specific output conditions on an if-then-basis. In this example the processing part 122 can test the received authentication information and decoded information as an input against the stored set of rules, in order to determine whether one or more of the rules are applicable to the received input, and to then subsequently generate the output on the basis of the applied rules.

The entity 120 generates an indication for a next code to be captured, which comprises information relating to an item and location associated with that next code. The specific nature and granularity of the item identification and location identification can be chosen in any suitable or desirable way for the application at hand. For example, in the context of examining codes on individual production items such as cigarette packs, the item identification can be brand information and the location identification can be the identification of a production site, a warehouse site, or a retail site. Naturally, these are only examples, and other configurations of information are envisionable.

The mobile device 110 furthermore comprises an output entity 113, which is controlled to output information relating to the item and location associated with a next code to be captured to a user of the mobile device. The output entity 113 can be chosen in any suitable or desirable way, for example it can be a display screen for visibly presenting information to a user, e.g. via a GUI (graphical user interface), an audio output such as a loudspeaker for providing acoustic output to a user, or a combination of visible and acoustic output systems.

The authentication information and decoded information is preferably stored in conjunction with one another in a database in the mobile device, e.g. in memory part 121. Furthermore, the mobile device is preferably arranged such that the authentication information and decoded information can be provided to a remote collection entity for such inspection or auditing data, e.g. a Web based server comprising an appropriate data base. The mobile device 110 may comprise a communication entity 115 for allowing communication with devices separate from the mobile device, either directly or via an appropriate communication network such as the Internet.

In the example of FIG. 1 the processing entity 120 is part of the mobile device 110. Such an embodiment provides a distinctive advantage over systems that rely on a permanent connection to an outside server for conducting certain processing tasks.

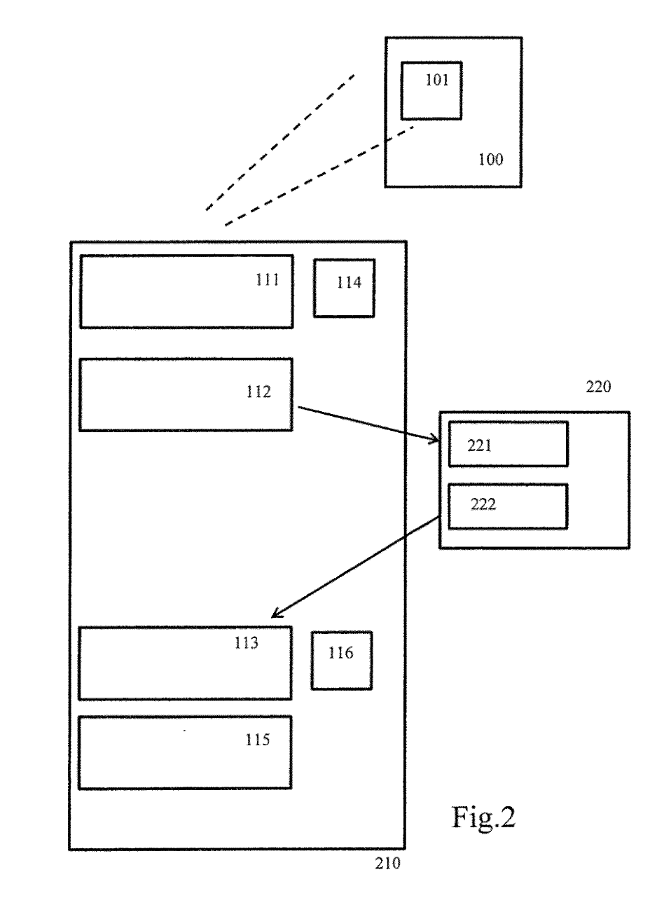

In an alternative embodiment shown in FIG. 2, the processing entity 220 is provided outside of the mobile device 210. The structure of mobile device 210 is otherwise identical to that of device 110 described in connection with FIG. 1, such that a repeated description of identical elements is not necessary. In the example of FIG. 2, mobile device 210 is equipped such that it can send the authentication information and the decoded information to the processing entity 220 that lies outside of the mobile device 210. This can be done by any suitable form of communication interface, for example in wireless or wire-bound fashion. As an example, mobile device 210 may comprise a communication entity 115 for external communication.

The external processing entity 220 can be arranged in close vicinity of the mobile device 210, for example in a computer device that stands in communication connection with a hand held scanner, but it also be at a remote location, for example in a network component of a communication network with which the mobile device 210 can communicate. As example, the processing entity 220 can be comprised within a server of a network such as the Internet, and mobile device 210 may be connectable to that network, e.g. via the communication interface 115.

The present invention can also be embodied in a form that combines the examples of FIGS. 1 and 2, in that the processing entity has a part provided within the mobile device and a part provided outside of the mobile device. In this case the task of the processing entity can be shared between the part in the mobile device and the part outside of the mobile device. For example, in this embodiment it is possible to arrange the system such that the task of the processing entity is handled by the part internal to the mobile device alone if no connection to the part outside of the mobile device is available or possible, and the task is shared between the two parts or handled by the external part alone if such a communication is available or possible at the time that the processing task is to be conducted. Such an embodiment provides a distinctive advantage over systems that depend on a permanent connection to an outside server such as a Web server for conducting certain processing tasks.

In the above-described examples, the code capturing entity 111 can be arranged such that it automatically detects data codes for capturing. For example, this can be done in such a way that a camera permanently records images and a code identifying algorithm permanently processes the images, in order to identify codes in such images. Preferably, the mobile device is arranged such that it has a user input entity 114, which allows the user to give user input that triggers the code capturing entity 111. Example, this can be a designated type of input device, such as a trigger button, but the user input entity 114 can also be part of a general-purpose user interface, such as a keyboard.

Preferably, a mobile device according to the present invention furthermore comprises an input entity for letting a user enter information in connection with codes being captured. For example, a keyboard can be provided such that a user can add text information describing specific circumstances or observations regarding the code being captured. Equally, an acoustic input entity such as a microphone can be provided. This additional user information can be stored in conjunction with the authentication information and decoded information, within the mobile device and/or at a remote location (for example a dedicated Web server) where the code inspection or auditing results are collected.

According to a further preferred example of the invention, the mobile device of any of the above-described embodiments preferably comprises a locating entity 116 that is adapted to generate location information associated with the location of the mobile device. The processing entity is then furthermore adapted to also receive the location information and to take into account this location information when generating the indication for the next code to be decoded. The locating entity can be provided in any suitable or desirable way, for example it can be adapted to generate the location information based on a GPS position and/or a triangulation position and/or an IP (Internet Protocol) address associated with the mobile device.

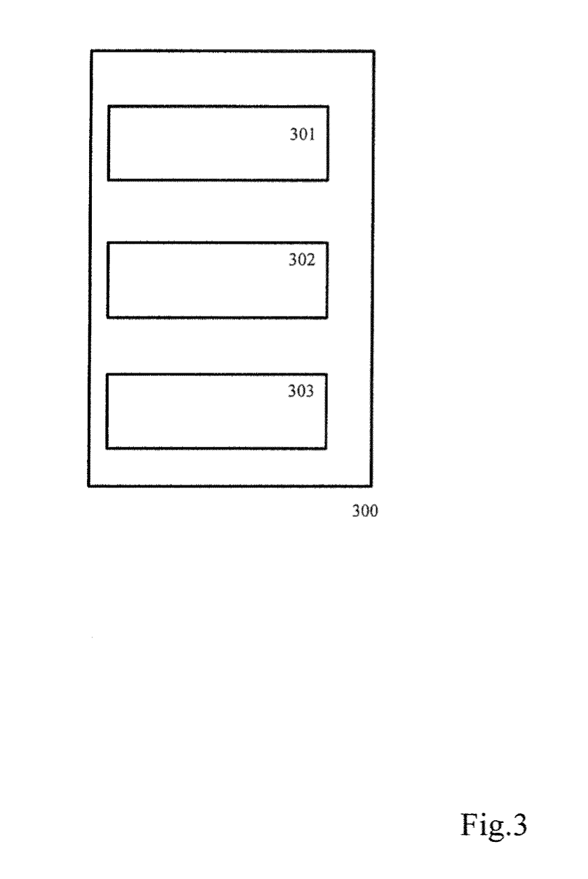

FIG. 3 relates to a further embodiment of the invention, where reference number 300 relates to a network component, for example a server in a communication network such as the Internet. The network component 300 comprises an information database 301 that comprises decoded information obtained from decoded data codes and authentication information obtained from an authentication operation performed on data codes. For example, the information database 301 can be a centralized database that records the results of code inspections or audits performed by one or more inspectors of data codes, for example by using mobile devices of the above described kind. Naturally, the information database 301 can be designed to record more information than just what is collected by the use of mobile devices of the above described kind. The network component 300 furthermore comprises a training entity 302 that is adapted to generate a prediction model based on the decoded information and the authentication information contained in the information database 301. Preferably this is done using data mining techniques. Finally, a communication entity 303 is provided, which is adapted to send the thus generated prediction model to a mobile device of the type described in connection with FIG. 1, in order to update a processing entity in that mobile device. The prediction model can equally be sent to processing entities or parts of processing entities provided outside of mobile devices as described in connection with FIG. 2.

The model may be provided in any suitable or desirable way, and is preferably such that it comprises a suitable set of rules generated by the training entity 302 based on the decoded information and the authentication information held in the information database 301. The model can e.g. be among any supervised learning model (such as decision tree, logistic regression, etc.).

An important benefit of the invention is to provide predictions for future codes to be captured based on statistics of past inspections or audits of codes. Trends in data can be detected and extracted using association rules. This leads to data-driven audits, which greatly enhances the utility of the mobile device as a tool.

In the following, a method for constructing a model will be described as a non-limiting example. The specific example relates to a decision tree. A decision tree is a data mining algorithm for constructing a prediction model from data. The final model is obtained by recursively partitioning the data space and fitting a simple prediction model within each partition. As a result, the partitioning can be represented graphically as a decision tree. Decision trees use measured prediction error as misclassification cost. Once a model (tree) is obtained, rules can be extracted. They facilitate model understanding and allow fast implementation. This is particularly useful in connection with keeping the mobile device simple when the model is deployed in the mobile device.

An example of decision tree representation is provided below. In Table 1, each line represents a specific inspection or audit. For each audited item, a set of parameters are obtained (P₁ to P₅) and is classified into one of the following class C: 1 (no fraud) or 2 (fraud).

TABLE 1
Input dataset for decision tree.

| P₁ | P₂ | P₃ | P₄ | P₅ | Class (C) |
|---|---|---|---|---|---|
| 10 | 15 | . . . | . . . | . . . | 1 |
| 10 | 15 | . . . | . . . | . . . | 1 |
| 10 | 25 | . . . | . . . | . . . | 1 |
| 20 | 15 | . . . | . . . | . . . | 2 |
| 20 | 25 | . . . | . . . | . . . | 2 |
| 20 | 15 | . . . | . . . | . . . | 1 |

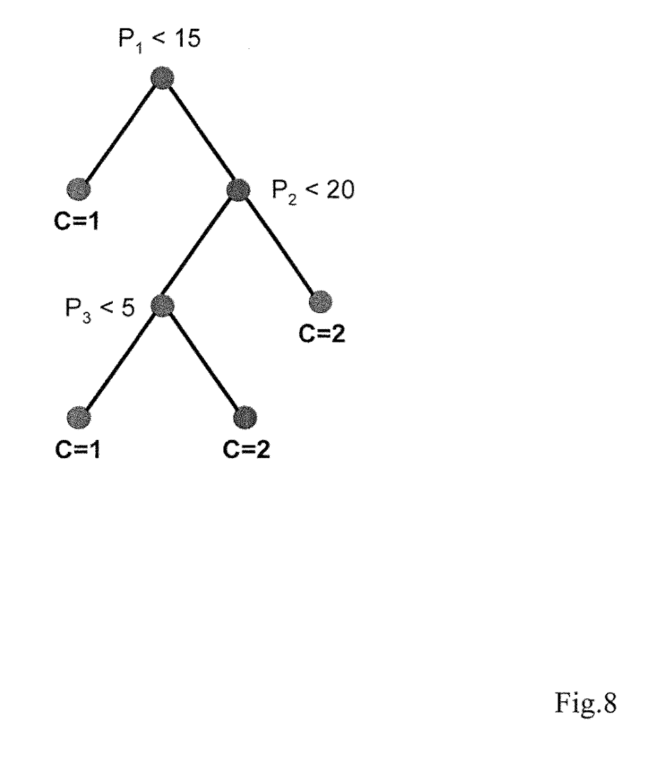

The process of building is summarized below. A decision tree can be built by successively setting threshold on chosen parameters in order to divide data into sub-groups that contain less disorder (e.g. measured by the Gini's Diversity Index, see below). The tree is preferably as small (simple) as possible to avoid unnecessary complexity. An example of decision tree building is provided based in Table 1. In addition to the class information (C), parameters P₁ to P₅ are taken into account. An example of decision tree is given in FIG. 8.

In the present example, data may first be randomized. This allows minimizing the risk of building a model that performs well only on collected data. Second, data may be separated into training and testing sets. The training set may e.g. consist of ⅔ of the data. Using these data, a decision tree can be built. The target for the decision tree is the class: no fraud (1) or fraud (2). The information criterion used, based on experimental tests, may be the Gini's Diversity Index (GDI) which is minimized:

$$GDI ( t ) = 1 - {\sum }_{i = 0}^{1} {[ p ( i \vert t ) ]}^{2}$$

where p(i|t) is the probability of belonging to class i at node t. It is possible to use other information criteria than GDI. In order to build the model (tree), the training set is used. A 10-fold cross-validation procedure is performed within the training set. The cross-validation serves to tune the model parameters (in this case the depth of the tree). Several trees may be built with varying depth. The best tree is the one with minimum cross-validation error. The obtained model may be tested using the test set (⅓ of the data).

Classification accuracy defined as the ratio of successes on the test set size:

$$Accuracy = \frac{{N}_{TP} + {N}_{TN}}{{N}_{TP} + {N}_{TN} + {N}_{FP} + {N}_{FN}} \cdot 100$$

where N_{TP} is the number of True Positive, N_{TN} is the number of True Negative, N_{FP} is the number of False Positive and N_{FN} is the number of False Negative. All these numbers refer to the test set. Once the tree is obtained, it can be transformed into a set of rules as shown below:

Node 1: If P1<15 then node 2 else if P1>=15 then node 3

Node 2: Class=1

Node 3: If P2<20 then node 4 else if P2>=20 then node 5

Node 4: If P3<5 then node 6 else node 7

Node 5: Class=2

Node 6: Class=1

Node 7: Class=2

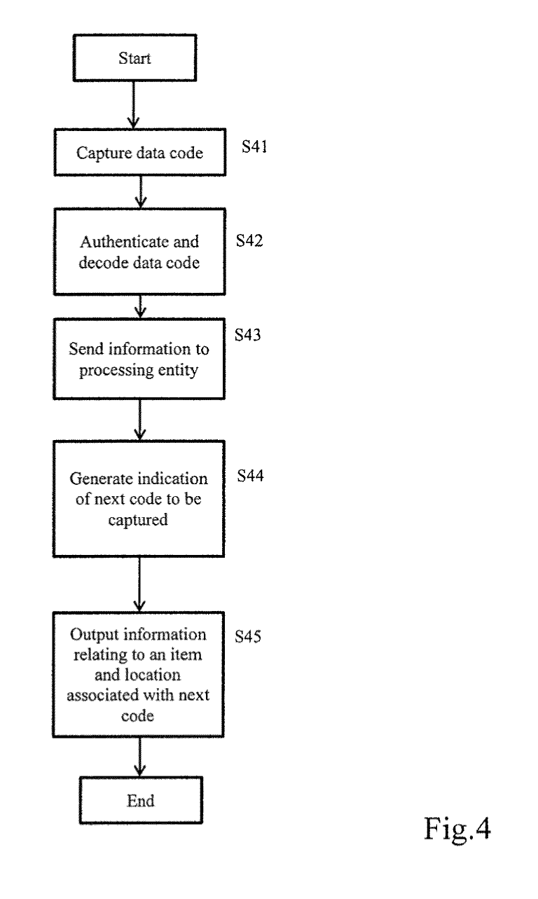

FIG. 4 shows a method embodiment of the invention, which shows a flowchart of a method for operating a mobile device of the above described kind. After start, in a step S41 a data code associated with an item is captured and in a subsequent step S42 the captured data code is authenticated and authentication information is generated as a result, and the captured data code is decoded, in order to obtain decoded information. In a step S43 the authentication information and decoded information is sent to a processing entity, and in a step S44 an indication of a next code to be captured is generated based on the authentication information and the decoded information by using the stored prediction model. Finally, in step S45 information relating to an item and location associated with the next code to be captured is output to a user based on that indication.

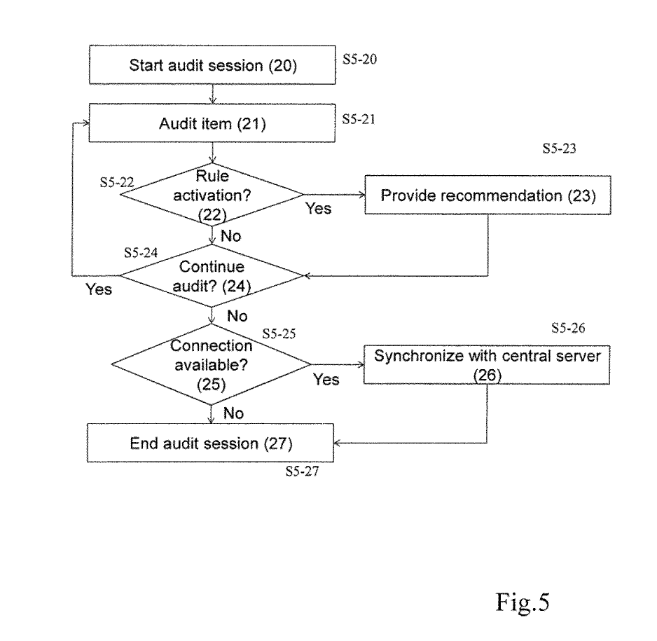

FIG. 5 shows a further example of a method embodiment of the present invention.

In step S5-20 the user starts an inspection or audit session using a mobile device of one of the above described kinds. In step S5-21 the user audits a specific item. In this example, it is assumed that the prediction model is rule based. In step S5-22 each rule in the processing entity 120 or 220 is checked. If a rule (e.g. of a decision tree) can be activated, it is applied, see step S5-23. If no rule is activated, there is no specific consequence. If one or more rules are activated, the output information relating to an item and location associated with a next code to be captured is given by the activated rule(s) through e.g. a graphical user interface, see step S5-23. In both cases, the user can decide to continue the audit or not, see step S5-24.

In step S5-25 it is checked whether a connection to a central server is available, and if so, synchronization can be made in step S5-26. The central server can e.g. be of the type described in connection with FIG. 3. The synchronization process can comprise one or both of updating the central database with authentication information and decoded information from the mobile device and updating the model stored in the processing entity 120 or 220. If no connection is available, the audit session is ended, step S5-27.

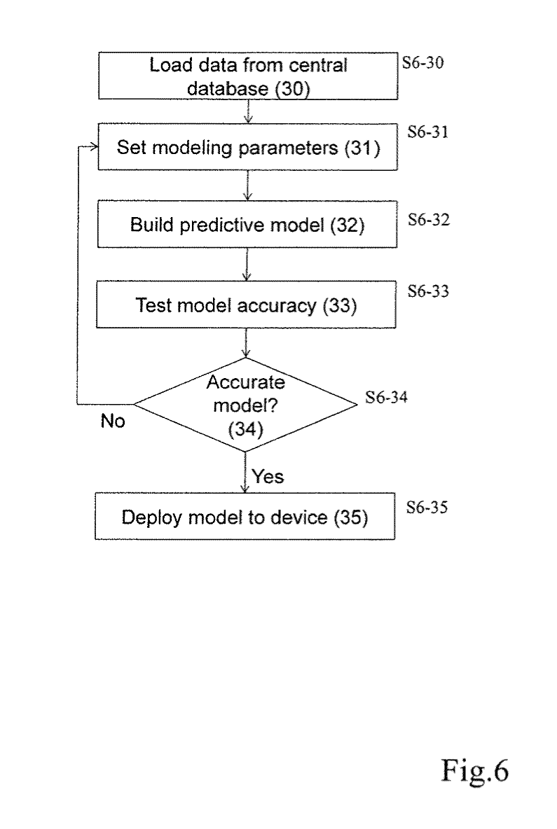

FIG. 6 shows a flowchart relating to a method embodiment of the invention for explaining an example of a model building process that can be conducted on the server remote to the mobile device, e.g. a network component as described in connection with FIG. 3.

In step S6-30 data is loaded from a central database, e.g. the information database 301 into a data mining module, which is an example of the training entity 302. In step S6-31 a user may set specific data mining model parameters. Step S6-32 describes building a predictive model based on specific parameters, which may be preset or have been set in step S6-31. In step S6-33 the predictive model obtained from S6-32 is tested with predetermined accuracy measures. If the model is not accurate enough, the process can return to step S6-31 to set new parameters and iterate the process again. If the performance is sufficient, the model can be deployed to the processing entities 120 or 220, see S6-35.

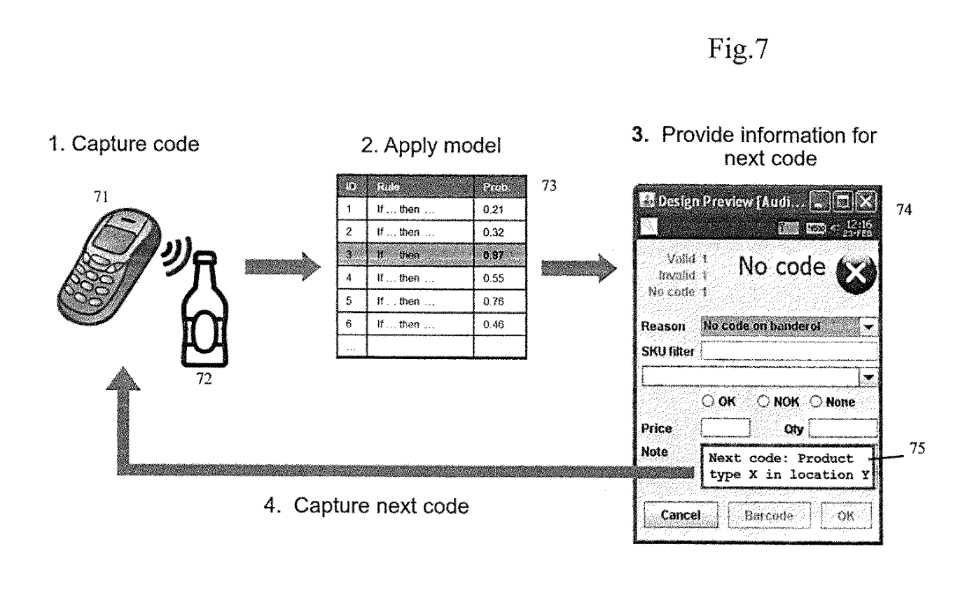

FIG. 7 schematically shows a further embodiment of the present invention, in which a mobile telephone is shown as an example of a mobile device and a beverage bottle 72 is shown as an example of an item. Table 73 represents a set of rules that constitute an example of a stored prediction model to be used for generating a next code to be captured. Reference numeral 74 represents an example of a visual output presented to a user on a screen of the device 71, where section 75 of the output gives the user information relating to an item and location associated with said next code to be captured.

An example of a rule in table 73 is:

IF month=January

AND Location=City center

AND Last product audit type=can

THEN product type X in location Y has fraud probability of 83%

This prediction may have e.g. been based on past data indicating that a fraud peak was reported in the previous year during January, close to the city center at location Y. Naturally, this is only an illustrative example and the structure of the rules or the basis for their determination may be varied as is suitable for the application at hand.

Although the invention has been described with reference to specific detailed embodiments and examples, this only serves to better illustrate the concepts without having limiting effect, as the invention is defined by the appended claims.

1. A mobile device comprising:
a code capturing entity adapted to capture a data code associated with an item;
an entity adapted to determine whether a captured data code is authentic and to generate authentication information as a result, and to decode the captured data code to obtain decoded information;
an output entity; and
wherein the mobile device is adapted such that the authentication information and the decoded information are sent to a processing entity which receives the authentication information and the decoded information and generates, based on the authentication information and the decoded information by using a stored prediction model, an indication for a next code to be captured; and
the output entity is arranged to output information relating to an item and location associated with said next code to be captured based on said indication.

2. The mobile device according to claim 1, wherein at least a part of the processing entity is located on the mobile device.

3. The mobile device according to claim 1, wherein at least a part of the processing entity is located outside of the mobile device.

4. The mobile device according to claim 1, further comprising a user input entity adapted to receive a user input, wherein the code capturing entity captures a code in response to a received user input.

5. The mobile device according to claim 1, further comprising a locating entity, the locating entity being adapted to generate location information associated with a location of the mobile device, and wherein the processing entity is adapted to also receive the location information and to take into account said location information when generating the indication for the next code to be decoded.

6. The mobile device according to claim 5, wherein the locating entity is adapted to generate the location information based on at least one of a GPS position, a triangulation position and an IP address associated with the mobile device.

7. The mobile device according to claim 1, wherein said prediction model comprises a decision tree.

8. A network component comprising:
an information database comprising decoded information obtained from decoded data codes and authentication information obtained from an authentication operation performed on data codes;
a training entity adapted to generate a prediction model based on the decoded information and the authentication information; and
a communication entity adapted to send the prediction model to a mobile device to update a processing entity in said mobile device.

9. The network component according to claim 7, wherein the model comprises a set of rules generated by the training entity based on the decoded information and the authentication information.

10. A method for operating mobile device, comprising:
capturing a data code associated with an item;
determining whether a captured data code is authentic and generating authentication information as a result, and decoding the captured data code to obtain decoded information;
sending the authentication information and the decoded information to a processing entity which receives the authentication information and the decoded information and generates, based on the authentication information and the decoded information by using a stored prediction model, an indication for a next code to be captured; and
outputting on a mobile device information relating to an item and location associated with said next code to be captured based on said indication.

11. The method according to claim 10, further comprising receiving a user input and capturing a code in response to the received user input.

12. The method according to claim 10, further comprising generating location information associated with the location of the mobile device, and taking into account said location information when generating the indication for the next code to be decoded.

13. The method according to claim 10, wherein said prediction model comprises a decision tree.

14. A method for operating a network component, comprising:
storing decoded information obtained from decoded data codes and authentication information obtained from an authentication operation performed on data codes;
generating a prediction model based on the decoded information and the authentication information; and
sending the prediction model to a mobile device to update a processing entity in said mobile device.

15. The method according to claim 14, wherein the model comprises a set of rules generated based on the decoded information and the authentication information.
